(19) United States
(12) Patent Application Publication
(10) Pub. No.: US 2021/0001593 A1
(43) Pub. Date: Jan. 7, 2021

(54) MAT

(71) Applicant: Chun-Fu KUO, Taichung City (TW)

(72) Inventor: Chun-Fu KUO, Taichung City (TW)

(21) Appl. No.: 16/460,703

(22) Filed: Jul. 2, 2019

(51) Int. Cl. B32B 5/02; B32B 3/26; B32B 27/12

(52) U.S. Cl. CPC B32B 5/024; B32B 3/266; B32B 2255/26; B32B 2471/04; B32B 2255/02; B32B 27/12

(57) ABSTRACT

A mat is provided, including: a woven, layer woven from at least one thread, the woven layer including a plurality of interwoven segments and a plurality of apertures formed by said plurality of interwoven segments, at least one of said plurality of interwoven segments including a core and a resin layer coated on an outer surface of the core, said plurality of interwoven segments are integrated and connected by melting bond of the resin layer of the at least one of said plurality of interwoven segments; a pad, made of a hydrophobic plastic material and is fixed to and under the woven layer, the pad including a plurality of passages, at least part of the plurality of apertures communicated with at least part of said plurality of passages.

### BACKGROUND OF THE INVENTION

### Field of the Invention

The present invention relates to a mat.

### Description of the Prior Art

Many places, such as toilets, bathrooms, kitchens, outdoor showers, or flushing locations, frequently use water and are usually equipped with mats for drainage and anti-slip to prevent the user from accidentally slipping due to water.

Generally, the mat used for the toilet and bathroom has a porous structure made of hard plastic material. Although it can effectively drain and is slip-proof, the mat is hard so that it does not feel good when treading on the mat.

It is also known to assemble wood boards on rigid plastic mats. In addition to high cost and heavy weight, the wood boards are also susceptible to problems of moisture, mildew, bacteria, spoilage, hygiene and service life.

Another type of conventional mat made of rubber is heavy, and it is only suitable for small areas and cannot be flexibly assembled or disassembled according to various requirements.

Another type of conventional cushion body is integrally formed of a foamed material. However, the upper portion of the conventional cushion body is easily damaged after being used for a long time because the user directly steps on the foamed material.

The present invention is, therefore, arisen to obviate or at least mitigate the above-mentioned disadvantages.

### SUMMARY OF THE INVENTION

The main object of the present invention is to provide a mat having advantages of: good hydrophobicity and good gas permeability, high strength, abrasion resistance, corrosion resistance, light weight, easy manufacture, low cost and long service life.

To achieve the above and other objects, the present invention provides a mat, including: a woven layer, woven from at least one thread, the woven layer including a plurality of interwoven segments and a plurality of apertures formed by said plurality of interwoven segments, at least one of said plurality of interwoven segments including a core and a resin layer coated on an outer surface of the core, said plurality of interwoven segments are integrated and connected by melting bond of the resin layer of the at least one of said plurality of interwoven segments; a pad, made of a hydrophobic plastic material and is fixed to and under the woven layer, the pad including a plurality of passages, at least part of the plurality of apertures communicated with at least part of said plurality of passages.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective breakdown drawing of a preferable embodiment of the present invention;

FIG. 2 is an enlargement of FIG. 1;

FIG. 3 is a partial cross-sectional view of a preferable embodiment of the present invention;

FIG. 4 is an enlargement of FIG. 3;

FIG. 5 is a partial cross-sectional view of another preferable embodiment of the present invention;

FIG. 6 is an enlargement of FIG. 5;

FIG. 7 is a partial stereogram of a woven layer of a preferable embodiment of the present invention; and

FIG. 8 is a partial cross-sectional view of the woven layer in FIG. 7 of a preferable embodiment of the present invention.

### DETAILED DESCRIPTION OF THE PREFERRED EMBODIMENTS

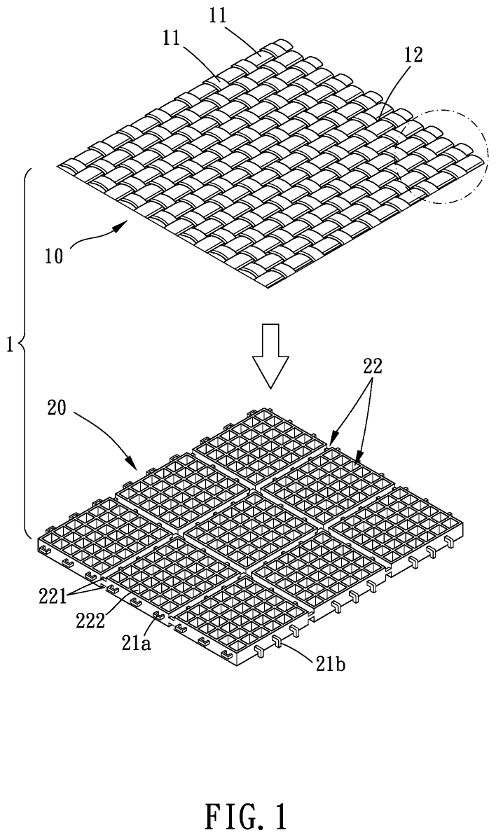

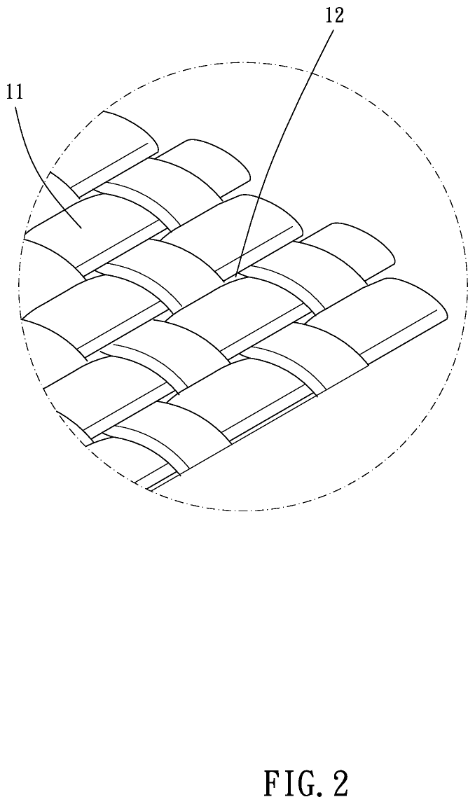

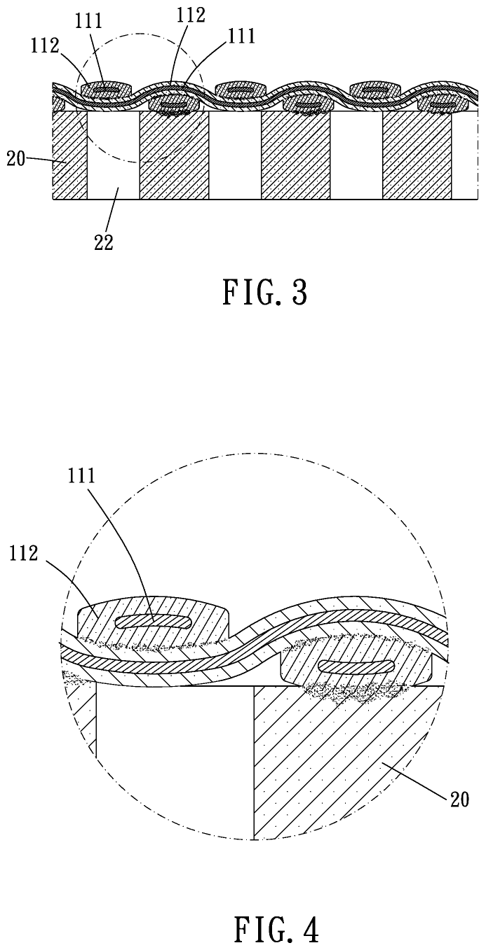

Please refer to FIGS. 1 to 8 for a preferable embodiment of the present invention. A mat 1 includes a woven layer 10 and a pad 20. The woven layer 10 is woven from at least one thread. The woven layer 10 includes a plurality of interwoven segments 11 and a plurality of apertures 12 formed by said plurality of interwoven segments 11. The sizes of the apertures 12 may be different according to widths and/or gaps of said plurality of interwoven segments 11. The woven layer 10 may be woven from only one thread or from a plurality of threads, and longitudinal portions and lateral portions of the woven layer 10 form said plurality of interwoven segments 11. At least one of said interwoven segments 11 (for example but is not limited to Textilene textile) includes a core 111 and a resin layer 112 coated on an outer surface of the core 111. The core 111 may be a single core or a bundle of fibers/filaments, wherein the core 111 may be formed be any suitable polyester fiber(s). Said plurality of interwoven segments 11 are integrated and connected by melting bond of [symbol] the at least one of the resin layer 112 of the at least one of said plurality of interwoven segments 11.

Preferably, the resin layer 112 is solid and water non-absorbent and non-foamed structure, which provides good structural properties and good hydrophobic effects, and which is well applicable to places such as bathroom, toilet or kitchen. The resin layer 112 may be selected from synthetic resin, polyvinyl chloride (PVC) or polyurethane (PU). Preferably, the resin layer 112 is made of polyvinyl chloride (PVC) which is tough, good support and resistant to acid and alkali.

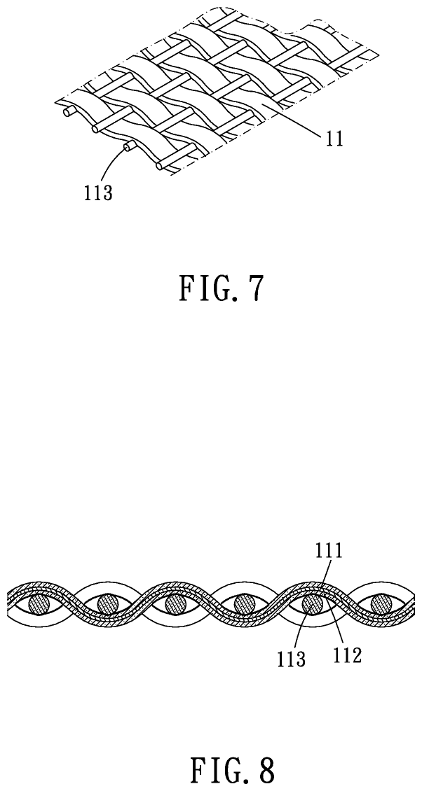

At least part of a plurality of contact portions of said plurality of interwoven segments 11 is fixedly and integrally bonded by the resin layer 112 of the at least one of said plurality of interwoven segments 11. In this embodiment, each of said plurality of interwoven segments 11 includes one said core 111 and one said resin layer 112, and all contact portions of said plurality of interwoven segments 11 are fixedly and integrally bonded by the resin layer 112 of respective one of said plurality of interwoven segments 11. However, as shown in FIGS. 7 and 8, a part or all of longitudinal portions (or lateral portions) of said plurality of interwoven segments 11 are provided with the core 111 and the resin layer 112 while all of lateral portions (or longitudinal portions) of said plurality of interwoven segments 11 are provided only with the core 111 but without the resin layer 112, wherein those interwoven segments 113, without the resin layer 112, of said plurality of interwoven segments 11 are fixedly and integrally bonded (non-annularly or annularly coated) by the resin layer 112 of other interwoven segments of said plurality of interwoven segments. As a result, said plurality of interwoven segments 11 are stably connected, without slippage and durable.

The pad 20 is made of a hydrophobic plastic material and is fixed to and under the woven layer 10, wherein “plastic” is meant that the material has plasticity but is not limited to plastics. The hydrophobic plastic material is formed by soft or hard water non-absorbent material, the hydrophobic plastic material may be foamed or unfoamed, and the hydrophobic plastic material may be thermoplastic or thermoset material. For example, the hydrophobic plastic material may be plastics, rubber or foam with sufficient support according to various requirements. Preferably, the pad 20 is integrally formed of one piece and without fibers or filaments, and the pad 20 has good structural strength and better support. The pad 20 preferably includes a plurality of buckle portions 21a, 21b on lateral sides so that the pad 20 can be optionally laid on various regions with different sizes. It is noted that the pad may be continuously or mass produced, by conventional foaming or 3D printing, from the hydrophobic plastic material so that the pad can be provided with large dimensions (large length and/or large width). The continuously or mass produced hydrophobic plastic material may be formed with foamed or holed structure and includes the passages, wherein the passages can be formed by processing the surface of the pad after the continuously or mass produced hydrophobic plastic material is formed, or the passages can be formed by the foamed holes or 3D printing holes of the pad. The continuously or mass produced hydrophobic plastic material may be bonded, without being cut into pieces, with the woven layer, or the continuously or mass produced hydrophobic plastic material may be cut into pieces and then bonded with the woven layer by a bonder such as resin, or the continuously or mass produced hydrophobic plastic material may be first entirely bonded with the woven layer and then cut into pieces.

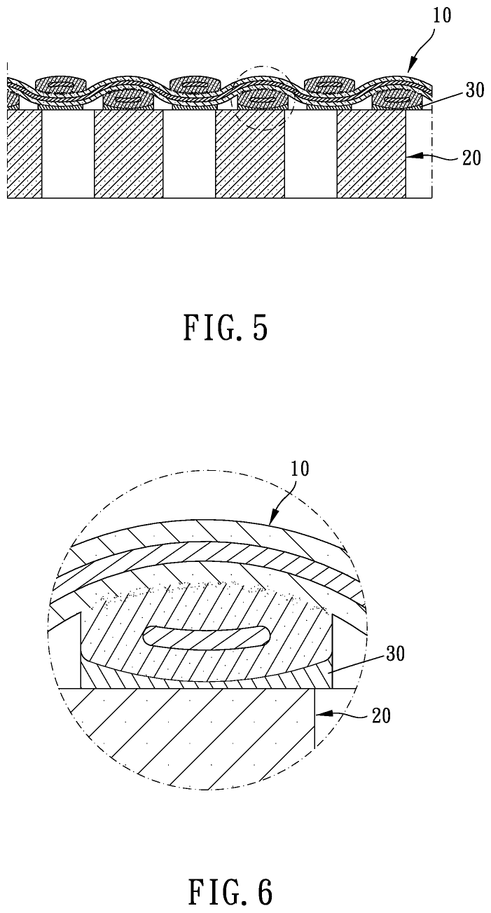

A top face of the pad 20 and the resin layer 112 of the at least one of said plurality of interwoven segments 11 are melted to integrally bond with each other, thus having good combination and being uneasy to detach. Preferably, the top face of the pad 20 and the resin layer 112 of said plurality of interwoven segments 11 are of homogeneous material. For example, the top face of the pad 20 and the resin layer 112 are made of PVC; however, the top face of the pad 20 and the resin layer 112 may be made of different materials as long as they can be melted to integrally bond with each other. In an alternative embodiment as shown in FIGS. 5 and 6, the woven layer 10 and the pad 20 can be bonded with each other by a bonder 30 such as resin. Preferably, the bonder 30 includes material which is homogeneous with the top face of the pad 20 and the resin layer 112, thus enhancing connection of the woven layer 10 and the pad 20.

The pad 20 includes a plurality of passages 22. At least part of the plurality of apertures 12 is communicated with at least part of said plurality of passages 22, for draining the water passing through the apertures 12 of the woven layer 10. Preferably, all of the plurality of apertures 12 are communicated with at least one of said passages 22, the size of the passage 22 is larger than the size of the aperture 12. Specifically, a total drainage cross-sectional area said plurality of passages 22 is at least two times a total drainage cross-sectional area of the plurality of apertures 12. An adequate total drainage cross-sectional area ratio of the apertures 12 and the passages 22 can efficiently and rapidly drain the water, and the woven layer 10 which is softer and thinner relative to the pad is uneasy to be depressed or deformed. Part of the plurality of apertures 12 may be blocked by the pad 20 to be uncommunicated with the passages 22, and the total drainage cross-sectional area is defined as a total cross-sectional area of the passages 22 and the apertures 12 allowing the water to pass therethrough after the woven layer 10 is bonded with the pad 20. The apertures 12 of the woven layer 10 each have a smaller size, thus effectively blocking foreign bodies such as dandruff and/or hair.

At least part of said plurality of passages 22 extends on at least one of an upper portion and a lower portion of the pad 20. In this embodiment, the passages 22 include a plurality of grooves 221 and a plurality of channels 222. The plurality of grooves 221 extend longitudinally and laterally on the upper portion and the lower portion of the pad 20, and the plurality of channels 222 are communicated between the top and bottom faces of the pad 20. Preferably, the plurality of grooves 221 are communicated with at least part of the plurality of channels 222, thus improving the drainage effect. It is noted that the passages may be formed merely on the upper portion of the pad but not through the pad; said plurality of passages may be configured to directly penetrate the pad, and the pad is provided without any groove thereon; said plurality of passages may be any configuration with a communicative structure communicating the interior and top and bottom faces.

Whereby, the mat of the invention has advantages of: good hydrophobicity and good gas permeability, high strength, abrasion resistance, corrosion resistance, light weight, easy manufacture, low cost and long service life.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mat, including:
a woven layer, woven from at least one thread, the woven layer including a plurality of interwoven segments and a plurality of apertures formed by said plurality of interwoven segments, at least one of said plurality of interwoven segments including a core and a resin layer coated on an outer surface of the core, said plurality of interwoven segments are integrated and connected by melting bond of the resin layer of the at least one of said plurality of interwoven segments;
a pad, made of a hydrophobic plastic material and is fixed to and under the woven layer, the pad including a plurality of passages, at least part of the plurality of apertures communicated with at least part of said plurality of passages.

2. The mat of claim 1, wherein the resin layer is a polyvinyl chloride (PVC) layer.

3. The mat of claim 1, wherein the resin layer is solid and water non-absorbent.

4. The mat of claim 1, wherein at least part of said plurality of passages extends on at least one of an upper portion and a lower portion of the pad.

5. The mat of claim 1, wherein a total drainage cross-sectional area of said plurality of passages is at least two times a total drainage cross-sectional area of the plurality of apertures.

6. The mat of claim 1, wherein at least part of a plurality of contact portions of said plurality of interwoven segments is fixedly and integrally bonded by the resin layer of the at least one of said plurality of interwoven segments.

7. The mat of claim 1, wherein each of said plurality of interwoven segments includes one said core and one said resin layer, and all contact portions of said plurality of interwoven segments are fixedly and integrally bonded by the resin layer of respective one of said plurality of interwoven segments.

8. The mat of claim 1, wherein the woven layer is fixed to the pad by a bonder.

9. The mat of claim 1, wherein a top face of the pad and the resin layer of the at least one of said plurality of interwoven segments are melted to integrally bond with each other.

10. The mat of claim 9, wherein a top face of the pad and the resin layer of the at least one of said plurality of interwoven segments are of homogeneous material.
